(19) United States
(12) Patent Application Publication
(10) Pub. No.: US 2007/0258757 A1
(43) Pub. Date: Nov. 8, 2007

(54) Adjustable extention

(76) Inventor: Clayburn Griffin JR., Hamilton, OH (US)

Correspondence Address: Clayburn Griffin, 901 South Ninth Street, Hamilton, OH, 45011, US

(21) Appl. No.: 11/418,727

(22) Filed: May 5, 2006

(51) Int. Cl. F16D 1/08

(52) U.S. Cl. 403/362

(57) ABSTRACT

This extension socket is like no other. It is able to be adjusted in length to fit various applications. Having two or more telescoping parts and a simple spring and lever to allow length adjustments to be made and held.

### BACKGROUND OF THE INVENTION

1. Field of Invention

This invention relates to extension sockets used with ratchets and sockets for mechanical repairs. It also relates to drills and drill bits.

2. Prior Art

Socket extensions in use today are all of a standard length. This means that current extensions do not always fit the restricted clearances on many repairs. As anyone who has taken anything apart knows,as you remove the bolt more space is taken up by it. As more space is taken up by the bolt the less space you have for your extension. If you use an extension that is to long to allow you to fully remove the bolt, then you could bind your ratchet. Since most ratchets have the direction switch on the back of the head this leaves you in a rough spot.

### OBJECTS AND ADVANTAGES

The advantages and objectives of the adjustable extension are to;
1. save time searching for just the right extension
2. saving weight in your tool box because you wont need as many extensions to do the same jobs
3. saving you the embarrassment of getting your ratchet stuck
4. saving you a few scraped knuckles.

Further objects and advantages are to give you a more adaptable tool, as well as a tool that will last for many years. More advantages may become apparent from a consideration of the following description an drawings.

### BRIEF SUMMARY OF THE INVENTION

The main feature of the adjustable extension is its ability to be adjusted in length by means of telescoping two or more parts. The other main feature is the ability to hold the adjustment by means of a spring and lever.

### BRIEF DESCRIPTION OF THE DRAWINGS

FIG. 1.

This is a view of the ratchet end of the collar and shows the square shape inside as well as the round shape outside.

FIG. 2.

This is both a side view and an end view of the inner bar. The end view shows the shape of this part. The side view shows how the locking teeth are located and the stops that prevent it from falling out or collapsing in to far. The stops are marked by arrows.

FIG. 3.

This is a view of the lock that holds the adjustment. It shows how the lock is placed. The lock is a spring and lever system.

FIG. 4.

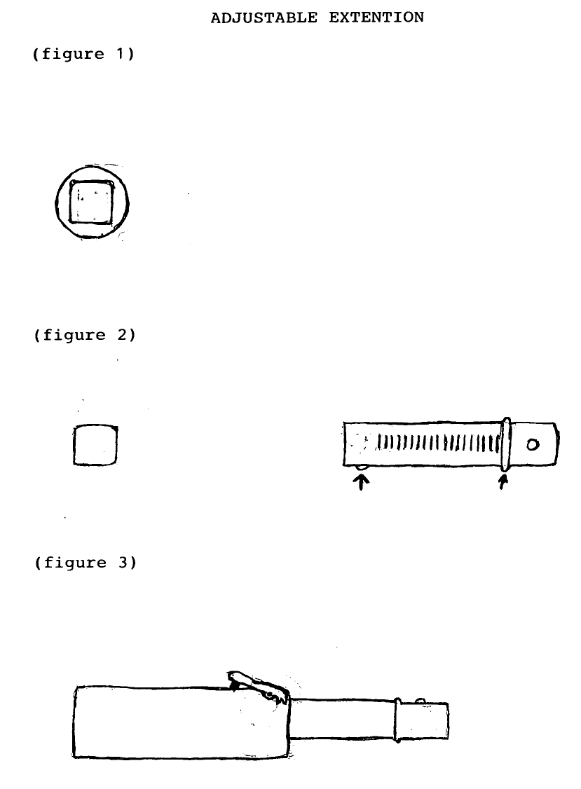

This is a view of the adjustable extension collapsed and extended to depict its movement.

### DETAILED DESCRIPTION OF THE INVENTION

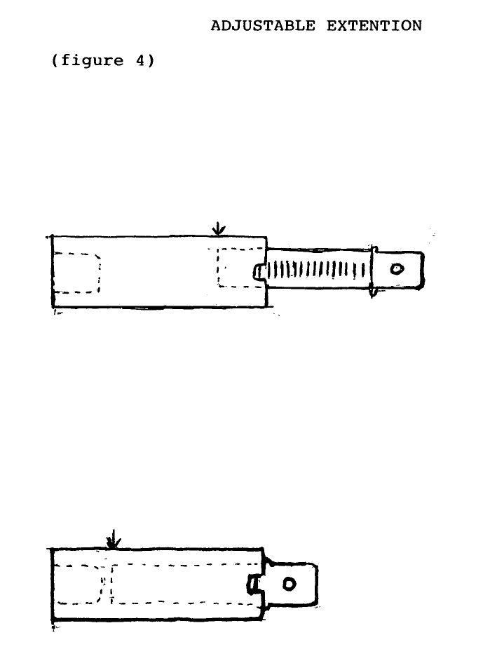

This invention is for the field of mechanical repairs. It is to be used in place of conventional extensions where the conventional ones do not work or need to be changed repeatedly. FIG. 4 shows an example of a 3.5 inch Adjustable Extension. It also shows the cutout for the lock. The lines represent the indentation of the teeth which are in 1/16 inch increments. The arrows indicate the overlap. The Adjustable Extension can be made in any length or ratchet drive size. On extensions longer than one foot the overlap should be increased. This is to improve strength and reduce sagging. There are some limits to the length, this is dependent on the drive size. Such as a 4 inch extension for a ½ inch drive could be collapsed to 3 inches. On a ⅜ inch drive a 3.5 inch extension could be collapsed to 2.5 inches. These would be the shortest available of a single telescoping model in these sizes. The lock shown in FIG. 2 is the inner rod. FIG. 2 shows that it is kept from falling out the same way a socket is held on. This spring loaded ball is on a different side than the locking teeth to prevent weakening of the connection. This is used in place of a solid stop so the two parts can be separated for cleaning.

### Alternative Use for the Adjustable Extension

This extension has applications in drilling also. It would allow clearance adjustments for drilling. Great for use on a drillpress when working with large and irregular shaped pieces. It would allow faster adjustments because you would only adjust the drill bit and not the work piece or stands.

What I claim as my invention is an extension socket that can be adjusted in length comprising:

1. two or more telescoping parts allowing adjustment of the length

2. a lever mechanism to hold said adjustment.
